(19) United States
(12) Patent Application Publication
(10) Pub. No.: US 2017/0277149 A1
(43) Pub. Date: Sep. 28, 2017

(54) CONTROL DEVICE WITH AUTOMATIC ADJUSTMENT

(71) Applicant: LITE-ON TECHNOLOGY CORPORATION, Taipei (TW)

(72) Inventors: Ming-Hung HUANG, Taipei (TW); Hung-Chun Li, Taipei (TW)

(21) Appl. No.: 15/621,735

(22) Filed: Jun. 13, 2017

Related U.S. Application Data
(63) Continuation-in-part of application No. 14/329,220, filed on Jul. 11, 2014.

(30) Foreign Application Priority Data
Oct. 22, 2013 (TW) 102138078

(51) Int. Cl. G05B 19/042; G06N 99/00; H05B 37/02; G01J 1/18; H05B 33/08; G05B 13/02

(52) U.S. Cl. CPC G05B 19/042; H05B 33/0872; G05B 13/02; H05B 37/0218; G01J 1/18; G06N 99/005; G05B 2219/25062

(57) ABSTRACT

A control device with automatic adjustment includes: an ambient light illumination sensor for sensing ambient light illumination information; and a microcontroller unit coupled to the ambient light illumination sensor. The microcontroller unit analyzes respective ambient illumination information at each of a plurality of time sessions. The microcontroller unit controls a controlled device based on the respective ambient illumination information at the time sessions.

This application is a CIP (continuation-in-part) of U.S. patent application Ser. No. 14/329,220 filed on Jul. 11, 2014, which claims the benefit of Taiwan application Serial No. 102138078, filed on Oct. 22, 2013, the subject matter of which are incorporated herein by reference.

### BACKGROUND

### Technical Field

The disclosure relates in general to a control device, and more particularly to a control device with automatic adjustment.

### Description of the Related Art

A control device controls a controlled device (for example, a lamp, a motor, and a solenoid valve) according to default turned-on conditions. The turned-on conditions include a time condition and/or an illumination condition, etc. The time condition, for example, refers to a time point at which the control device controls the controlled device, such as turning on/off the controlled device. The illumination condition, for example, refers to that, when the illumination is under/above an illumination threshold, the control device performs a corresponding control operation.

When the time condition is used as a turned-on condition for controlling the controlled device, the control device includes a counter which counts time and provides the time information. Once the time information provided by the counter meets the default time condition, the control device will perform a corresponding control operation on the controlled device.

When the illumination condition is used as a turned-on condition for controlling the controlled device, the control device includes an ambient light illumination sensor which senses an ambient illumination, so that the control device performs a relevant operation according to the sensed illumination information. Once the sensed illumination information meets a default illumination condition, the control device will perform a corresponding control operation on the controlled device.

The control devices are widely used. Therefore, how to maintain the reliability and convenience of the control device has become a prominent task for people in the related technology.

### SUMMARY OF THE DISCLOSURE

According to one embodiment of the present disclosure, a control device with automatic adjustment is provided. The control device with automatic adjustment includes: an ambient light illumination sensor for sensing ambient light illumination information; and a microcontroller unit coupled to the ambient light illumination sensor. The microcontroller unit analyzes respective ambient illumination information at each of a plurality of time sessions. The microcontroller unit controls a controlled device based on the respective ambient illumination information at the time sessions.

The above and other contents of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 is a block diagram of a control device with automatic adjustment according to an embodiment of the disclosure.

FIG. 2 is a block diagram of a control device with automatic adjustment according to another embodiment of the disclosure.

FIG. 3A and FIG. 3B show examples of controlling the lighting device (or the streetlight) based on the measured illumination information in the embodiment of the application.

### DETAILED DESCRIPTION OF THE DISCLOSURE

Technical terms of the disclosure are based on general definition in the technical field of the disclosure. If the disclosure describes or explains one or some terms, definition of the terms is based on the description or explanation of the disclosure. Description on the common technologies or theories is omitted if they do not involve the technical features of the disclosure. Further, shapes, sizes and ratios of the objects are exemplary for one skilled person in the art to understand the disclosure, not to limit the disclosure.

Each of the disclosed embodiments has one or more technical features. In possible implementation, one skilled person in the art would selectively implement part or all technical features of any embodiment of the disclosure or selectively combine part or all technical features of the embodiments of the disclosure.

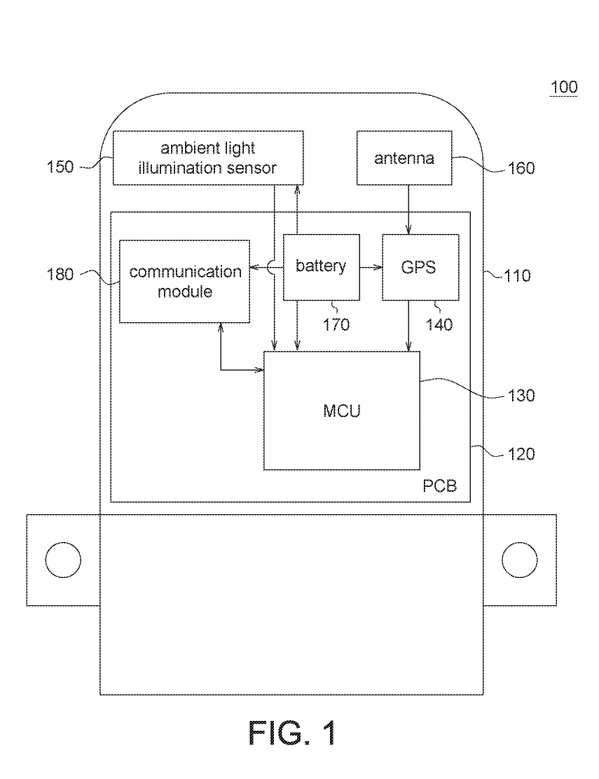

Referring to FIG. 1, a block diagram of a control device with automatic adjustment according to an embodiment of the disclosure is shown. As indicated in FIG. 1, the control device 100 with automatic adjustment includes a housing 110, a circuit board (such as a printed circuit board (PCB)) 120, a microcontroller unit (MCU) 130, a GPS module 140, an ambient light illumination sensor 150, antenna 160 and a battery 170. Besides, the control device 100 may selectively include a communication module 180.

The housing 110 is a waterproof housing, such that even if the control device 100 is installed in an outdoor environment, by a window or under an arcade of a building, the electronic components of the control device 100 will not be moisturized and the lifespan of the electronic components may thus be prolonged.

The circuit board 120 is installed inside the housing 110. Electronic components, such as the microcontroller unit 130, the GPS module 140, the battery 170 and the communication module 180, are disposed on the circuit board 120.

The microcontroller unit 130 receives information from the GPS module 140, the ambient light illumination sensor 150 and the communication module 180. Also, the microcontroller unit 130 may send out information, such as location information, via the communication module 180. In the present disclosure, the microcontroller unit 130 is further equipped with a control function and an automatic adjustment function, and detailed descriptions of the microcontroller unit 130 are elaborated below. In short, the microcontroller unit 130 may update a control setting value based on information provided by the GPS module 140. The microcontroller unit 130 may adjust a time reference based on the control setting value, to control at least a controlled device (such as a lamp, a motor, a solenoid valve, and so on) or to control at least a controlled device (such as a lamp, a motor, a solenoid valve, and so on) based on the control setting value and the ambient illumination information from the ambient light illumination sensor 150.

Suppose the microcontroller unit 130 is used to control the lamp based on the control setting value and the ambient illumination information from the ambient light illumination sensor 150. The microcontroller unit 130 may control (turn on) the lamp to provide illumination if the microcontroller unit 130 determines that the ambient illumination is too dark (i.e. the ambient illumination information is lower than the control setting value) after comparing the control setting value with the ambient illumination information (representing a illumination of the sunlight) from the ambient light illumination sensor 150.

The GPS module 140 receives satellite information (such as time information and location information) transmitted from a GPS satellite, and further transmits to the microcontroller unit 130. The GPS module 140 receives information from the GPS satellite via the antenna 160.

The ambient light illumination sensor 150 senses an ambient illumination, and further transmits the sensing result (the ambient illumination information) to the microcontroller unit 130.

The battery 170 provides power to electronic components inside the control device 100. The electronic components are such as the microcontroller unit 130, the GPS module 140, the ambient light illumination sensor 150 and the communication module 180. The battery 170 of the present embodiment is realized by a lithium battery, but the disclosure is not limited thereto.

The communication module 180 may be equipped with such as 3G communication function, Wi-Fi communication function, and so on. The communication module 180 is controlled by the microcontroller unit 130 to communicate with the external environment. In an embodiment, after the communication module 180 receives the location information of the control device 100 from the microcontroller unit 130, the communication module 180 sends out the location information of the control device 100 to an external control center. Thus, the external control center obtains the location of the control device 100 and the maintenance of the control device 100 is made more convenient.

Details of how the technical characteristics of the disclosure are made by the control device and the GPS module are disclosed below.

In an embodiment of the disclosure, the date and time information provided by the GPS module 140 may be used as an updated time reference (the control setting value), and the microcontroller unit 130 may periodically adjust the counter. For example, the microcontroller unit 130 adjusts the counter daily, but the disclosure is not limited thereto. By doing so, the error of the counter may be reduced to be as small as tens of milliseconds, and the accuracy in the time control on the controlled device may be improved. In an embodiment of the disclosure, the counter may be an internal component of the microcontroller unit 130 or a component independent from the microcontroller unit 130.

Besides, the microcontroller unit 130 may use the date and time information provided by the GPS module 140 as a reference, such that the control device 100, in conjunction with related firmware, may have the perpetual calendar and time control function even without additional hardware. Therefore, the perpetual calendar and time control function of the control device 100 will not be affected even if the counter is aged.

According to the above embodiments, the control device 100 may automatically adjust the time reference (the control setting value) based on the date and time information provided by the GPS module 140 to avoid control on the controlled device at wrong timing which is caused by the error of the counter, and to increase the reliability of the control device 100. Since the counter is normally realized by an oscillation component, aging of the counter will occur after a long duration of use.

Details of how the control device, the GPS module 140 and the ambient light illumination sensor 150 achieve the technical characteristics of the disclosure are disclosed below.

In the present embodiment, the control device 100 achieves the “self-on-site learning” function by using the date and time information provided by the GPS module 140. In an embodiment, the microcontroller unit 130 may divide a day into a plurality of time sessions (such as 24 time sessions) based on the date and time information provided by the GPS module 140, and obtain the illumination information sensed by the ambient light illumination sensor 150 at respective time session. The microcontroller unit 130 may obtain the illumination change over a whole day based on the time sessions and the illumination information of the time sessions to generate an updated time condition (the control setting value). For example, the microcontroller unit 130 may obtain a time session during which the ambient light gets dark based on the illumination change over a whole day, and accordingly adjusts the time condition based on the time session during which the ambient light gets dark.

In another embodiment, the microcontroller unit 130 may obtain the illumination information sensed by the ambient light illumination sensor 150 at a specific time session for many days based on the date and time information provided by the GPS module 140. The microcontroller unit 130 performs statistical analysis on the above illumination information, and accordingly generates an updated illumination condition (the control setting value). For example, the microcontroller unit 130 may obtain illumination information sensed by the ambient light illumination sensor 150 at 6 pm for many days and further use the statistical value as an updated illumination condition. The statistic value is exemplified by an average value or a median value but the present embodiment is not limited thereto. Suppose the controlled device is a lamp. If the current ambient illumination is larger than the updated illumination condition, this means that the illumination is bright enough and the control device 100 will not turn on the lamp. Conversely, if the current ambient illumination is smaller than the updated illumination condition, this means that the illumination is not bright enough and the control device 100 will turn on the lamp.

A self-on-site learning operation is performed in an embodiment of the disclosure because the original control setting value may not be suitable for every location. Since the sun angle may be different from location to location, the illumination sensed at the same time session but different locations may not be the same. In the present embodiment, by performing a self-on-site learning operation, the averaged illumination value will gradually conform to the local illumination of the sunlight at the time session.

Conversely, suppose the default turned-on condition cannot be adjusted. When the ambient condition at an installation site has changed, the control device will still perform the control operation on the controlled device based on the default turned-on condition, which is no longer conformed to the already-changed ambient condition. Consequently, the control device may turn on the controlled device under an erroneous condition. However, the embodiment of the disclosure avoids the occurrence of such problems.

In addition, the ambient condition at each installation site is different. If the self-on-site learning operation is unavailable, the respective default turned-on condition at each installation site must be manually set during the installation process, not only taking a considerable amount of time but also bringing tremendous inconvenience to the installation process. However, the embodiment of the disclosure avoids the occurrence of such problems.

Apart from sensing and obtaining local illumination information by using the ambient light illumination sensor 150, in another embodiment of the disclosure, the turned-on condition (the control setting value) may further be compensated or fine-tuned based on the location information (the longitude/latitude information) provided by the GPS module 140 and a local ambient parameter. The local ambient parameter is such as sunrise/sunset time and/or sun angle information. In an embodiment of the disclosure, the microcontroller unit 130, based on the location information (the longitude/latitude information) provided by the GPS module 140, may obtain a local ambient parameter from a database. Then, the microcontroller unit 130 may calculate a compensation value based on the local ambient parameter to compensate or fine-tune the turned-on condition. In an embodiment of the disclosure, the database may be pre-stored in the control device 100 or may be searched by the microcontroller unit 130 through network.

The turned-on condition is compensated or fine-tuned in an embodiment of the disclosure because illumination may change dramatically when the sun sets in a flash. In the present embodiment, the microcontroller unit 130, based on the calculated information, determines whether to fine-tune the control setting value and to what degree will the control setting value be compensated or fine-tuned.

As disclosed in the above embodiments, the control device 100 may automatically adjust the turned-on condition (the control setting value) based on the date, time or location information provided by the GPS module to avoid manual adjustment of the turned-on condition at respective installation site, which reduces time and manual burden.

The control device of the embodiment of the disclosure is capable of adjusting or updating a control setting value (such as time reference, the turned-on condition and so on) based on the information provided by a GPS module so as to accordingly increase the reliability and installation convenience of the control device.

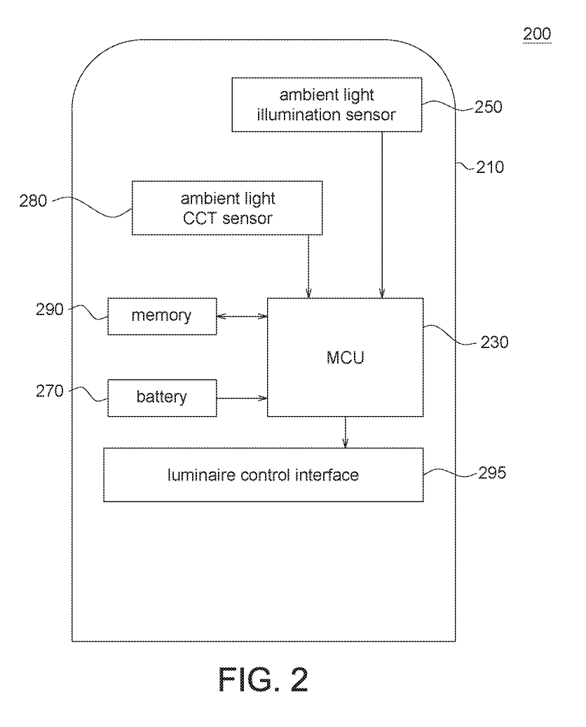

Referring to FIG. 2, a block diagram of a control device with automatic adjustment according to another embodiment of the disclosure is shown. As indicated in FIG. 2, the control device 200 with automatic adjustment includes a housing 210, a microcontroller unit (MCU) 230, an ambient light illumination sensor 250, a battery 270, an ambient light CCT (Correlated color temperature) sensor 280, a memory 290 and a luminaire control interface 295. The house 210, the ambient light illumination sensor 250 and the battery 270 are the same or similar to the house 110, the ambient light illumination sensor 150 and the battery 170 of FIG. 1 and thus the details thereof are omitted here.

The microcontroller unit 230 is coupled to the ambient light illumination sensor 250, the battery 270, the ambient light CCT sensor 280, the memory 290 and the luminaire control interface 295. The MCU 230 receives information from the ambient light illumination sensor 250 and the ambient light CCT sensor 280 and stores the received information into the memory 290. Also, MCU 230 may send out control information to the luminaire control interface 295. In the present disclosure, the MCU 230 is further equipped with a control function and an automatic adjustment function, and detailed descriptions of the MCU 230 are elaborated below.

In an embodiment, the MCU 230 may divide a day into a plurality of time sessions (such as 24 or 48 time sessions), and obtain the illumination information sensed by the ambient light illumination sensor 250 and the light color temperature information sensed by the ambient light CCT sensor 280 at respective time session. In another embodiment, the MCU 230 may obtain the illumination information sensed by the ambient light illumination sensor 250 and the light color temperature information sensed by the ambient light CCT sensor 280 at a specific time session for many days.

The ambient light illumination sensor 250 senses ambient light illumination information and sends to the MCU 230.

The ambient light CCT sensor 280 is used to detect ambient light color temperature information and sends to the MCU 230.

The memory 290 is used to store information sensed by the ambient light illumination sensor 250 and the ambient light CCT sensor 280. Further, the memory 290 is used to store information processed by the MCU 230. Further, the memory 290 is used to store information necessary by the MCU 230.

The luminaire control interface 295 is used to transform the MCU signal from the MCU 230 into a control signal for controlling a device or equipment controllable by the control device 200.

The control device 200 may be used to automatically detect and record the environment light information (for example but not limited, environment light illumination information and/or environment light color temperature information) to predict the sunset time and/or the sunrise time in future days. Further, the control device 200 may be used to automatically control the ON/OFF operations of the device under control (for example but not limited by, the streetlight) and/or to adjust the illumination of the streetlight based on the environment light information and/or the predicted sunset time and/or the sunrise time in future days. Thus, before sunset, the streetlight will be turned on and further the illumination of the streetlight will be automatically controlled by the control device 200.

Also, in other possible embodiments of the disclosure, the control device 200 may be used to automatically control the lighting devices in greenhouse or in plant factory. Thus, when the sunshine intensity is not enough, the control device 200 may automatically control the ON/OFF and/or illumination of the lighting devices in greenhouse or in plant factory.

Still further, in other possible embodiments of the application, the MCU 230 may automatically exclude the undesired environment light color temperature information. For example, in one possible example, in predicting the sunset time, the MCU 230 may exclude the environment light color temperature information which is higher than or equal to a predetermined threshold (for example but not limited by 7000K). This is because, basically, in rainy time or cloudy time, the environment light color temperature information is higher than or equal to the threshold (7000K). Thus, in order to correctly predict the sunset time, the MCU 230 may exclude the environment light color temperature information which is measured in rainy time or cloudy time. For example, if it rains at PM 3:00 on May 31th and thus the environment light color temperature information measured will be higher than the predetermined threshold, the MCU 230 of the control device 200 of the embodiment of the application may exclude the environment light color temperature information measured at PM 3:00 on May 31th.

In still other example, the MCU 230 may calibrate the predetermined threshold based on the geographic location of the control device 200, wherein the geographic location of the control device 200 may be measured by a GPS module (not shown). For example, if the geographic location of the control device 200 is at high latitude, then the predetermined threshold may be calibrated as being higher and vice versa.

In other possible example of the application, a color temperature table may be established in the memory 290. The color temperature table may include, for example but not limited by, the following table (ACTR: Allowable color temperature range):

| time | ACTR |
|---|---|
| AM 5:00-AM 6:00 | 2000K-2500K |
| AM 6:00-AM 7:00 | 2500K-2500K |
| AM 7:00-AM 9:00 | 3500K-4700K |
| AM 9:00-PM 4:00 | 5000K-5800K |
| PM 4:00-PM 5:00 | 3500K-4700K |
| PM 5:00-PM 6:00 | 2500K-2500K |
| PM 6:00-PM 7:00 | 1500K-2000K |

If the measured environment light color temperature information is not in the ACTR (allowable color temperature range), then the measured environment light color temperature information will be excluded. For example, if at AM 10:00, the measured environment light color temperature information is 5700K (which is within 5000K-5800K ACTR of AM9:00-PM4:00), then this measured environment light color temperature information is used to predict the sunset time. On the contrary, if at AM 10:00, the measured environment light color temperature information is 6500K (which is not in 5000K-5800K ACTR of AM9:00-PM4:00), then this measured environment light color temperature information (6500K) is excluded in predicting the sunset time.

In the embodiment of the application, the ambient light CCT sensor 280 may be configured to periodically or non-periodically measure the environment light color temperature information. For example but not limited by, the ambient light CCT sensor 280 may be configured to measure the environment light color temperature information at every 30 minutes.

In still other example, the ACTR (allowable color temperature range) may be calibrated by the MCU 230 based on the geographic location of the control device 200, wherein the geographic location of the control device 200 may be measured by a GPS module (not shown). For example, if the geographic location of the control device 200 is at high latitude, then the ACRT may be calibrated as being higher and vice versa.

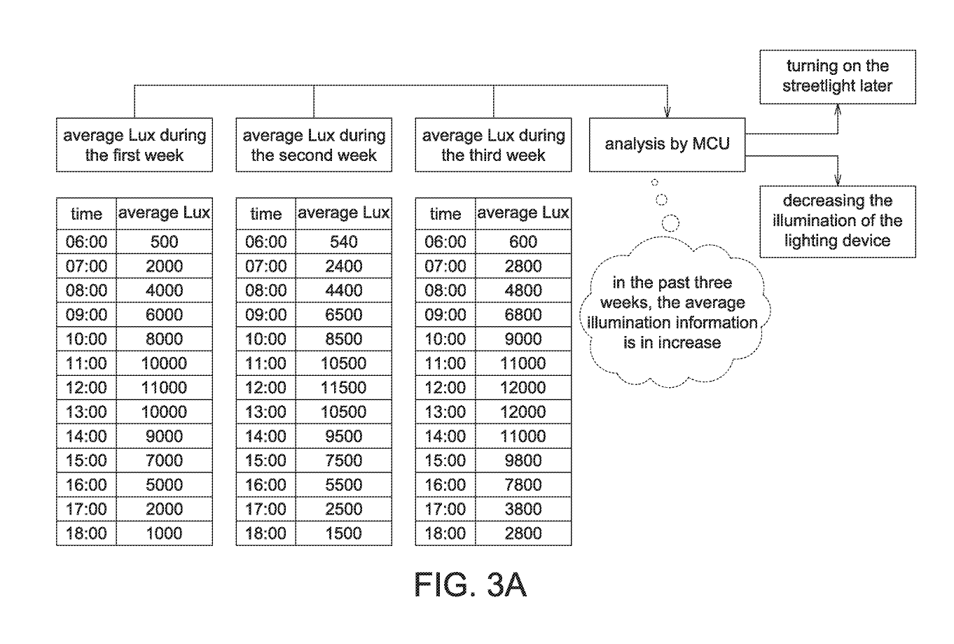

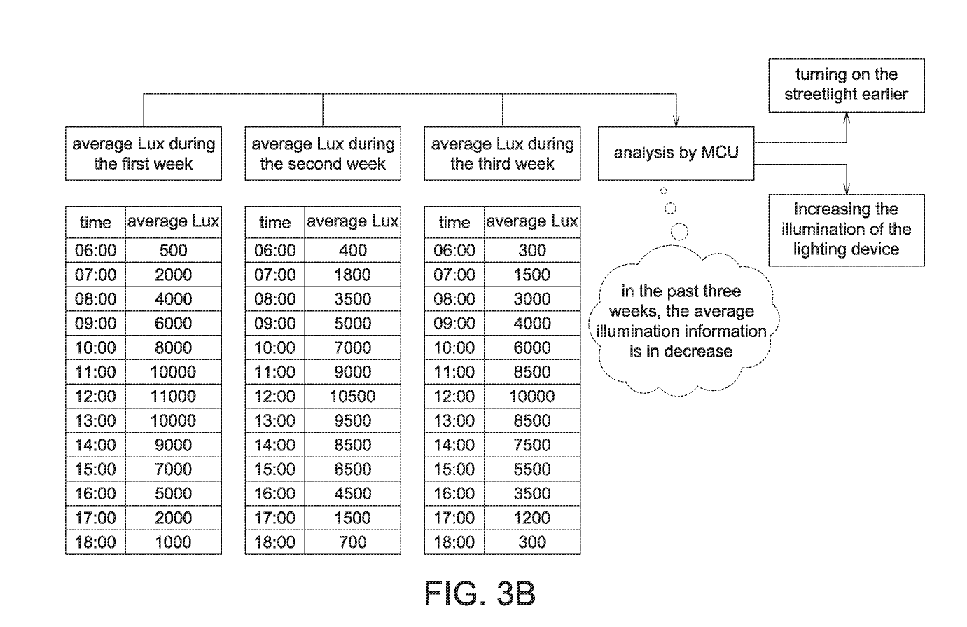

FIG. 3A and FIG. 3B show examples of controlling the lighting device (or the streetlight) based on the measured illumination information in the embodiment of the application. As show in FIG. 3A, the MCU 230 may calculate the average Lux (illumination) information of the past time interval (for example but not limited by during the first three weeks) based on the measured illumination information, and stores the average Lux information in the memory 290. After the MCU 230 analyzes the average Lux (illumination) information during the first three weeks, the MCU 230 determines that in the past three weeks, the average illumination information is in increase (for example, in the past three weeks, the average Lux information at 06:00 is 500, 540 and 600, respectively). That is to say, the MCU 230 determines that the sunset time in future days may be later or determines that the sunshine intensity is stronger. Then, the MCU 230 determines to turn on the streetlight later than the current setting or to decrease the illumination of the lighting device.

similarly, as shown in FIG. 3B, after the MCU 230 analyzes the average Lux (illumination) information during the time interval, the MCU 230 determines that in the past three weeks, the average illumination information is in decrease (for example, in the past three weeks, the average Lux information at 06:00 is 500, 400 and 300, respectively). That is to say, the MCU 230 determines that the sunset time in future days may be earlier or determines that the sunshine intensity is weaker. Then, the MCU 230 determines to turn on the streetlight earlier than the current setting or to increase the illumination of the lighting device.

Further, the embodiments in FIG. 1 and FIG. 2 may be selectively combined, which is still within the spirit and scope of the application.

According to the above embodiment, the control device 200 may automatically control the power-on time of the lighting device and/or the illumination of the lighting device based on the ambient light illumination information and the ambient light color temperature information.

While the disclosure has been described by way of example and in terms of the preferred embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A control device with automatic adjustment, comprising:
an ambient light illumination sensor configured to sense ambient light illumination information; and
a microcontroller unit coupled to the ambient light illumination sensor,
wherein
the microcontroller unit analyzes respective ambient illumination information at each of a plurality of time sessions; and
the microcontroller unit controls a controlled device based on the respective ambient illumination information at the time sessions.

2. The control device according to claim 1, wherein
the microcontroller unit further analyzes a plurality of ambient illumination information corresponding to a specific time session in a plurality of days; and
the microcontroller unit further controls the controlled device based on the plurality of ambient illumination information corresponding to the specific time session in the plurality of days.

3. The control device according to claim 1, further including:
an ambient light CCT (Correlated color temperature) sensor, coupled to the microcontroller unit for sensing ambient light color temperature information and sending to the microcontroller unit,
wherein the microcontroller unit further controls the controlled device based on the ambient light color temperature information.

4. The control device according to claim 3, wherein the microcontroller unit excludes the ambient light color temperature information based on a predetermined threshold.

5. The control device according to claim 4, wherein the microcontroller unit calibrates the predetermined threshold based on a geographic location of the control device.

6. The control device according to claim 3, wherein the microcontroller unit compares the ambient light color temperature information with a corresponding one of a plurality of allowable color temperature ranges at a corresponding one of a plurality of time sessions to determine whether to exclude the ambient light color temperature information.

7. The control device according to claim 6, wherein the microcontroller unit calibrates the plurality of allowable color temperature ranges based on a geographic location of the control device.
